(19) United States
(12) Patent Application Publication
(10) Pub. No.: US 2007/0244755 A1
(43) Pub. Date: Oct. 18, 2007

(54) METHOD AND SYSTEM FOR CREATING ADVERTISEMENT-LIST BY VALUE DISTRIBUTION

(75) Inventor: Gwan-Pyo Do, Gyeonggi-do (KR)

Correspondence Address: BLACKWELL SANDERS LLP, 720 OLIVE STREET, SUITE 2400, ST. LOUIS, MO, 63101, US

(73) Assignee: NHN CORPORATION, Kyunggi-do (KR)

(21) Appl. No.: 11/691,563

(22) Filed: Mar. 27, 2007

(30) Foreign Application Priority Data
Mar. 28, 2006 (KR) 10-2006-0027928

(51) Int. Cl. G06Q 30/00

(52) U.S. Cl. 705/14

(57) ABSTRACT

A method and system for creating an advertising system according to a value distribution, which can determine a degree of relatedness between advertising information and a content page by utilizing various types of point values, and create an advertising list by utilizing more related advertising information, is provided. According to the present invention, there is provided a method and system for creating an advertising list according to a value distribution, which can extract advertising information for contextual advertising and determine a location of each of the extracted advertising information in the advertising list by considering various types of point values, and thereby can retrieve advertising information, which is optimal for a content of a content page, and create the advertising list including the retrieved optimal advertising information.

### CROSS-REFERENCE TO RELATED APPLICATION

This application claims the benefit of Korean Patent Application No. 10-2006-0027928, filed on Mar. 28, 2006, in the Korean Intellectual Property Office, the disclosure of which is incorporated herein by reference.

### BACKGROUND OF THE INVENTION

1. Field of the Invention

The present invention relates to a method and system for creating an advertising system according to a value distribution, which can determine a degree of relatedness between advertising information and a content page by utilizing various types of point values, and create an advertising list by utilizing more related advertising information.

2. Description of Related Art

Among current advertising services, a contextual advertising service identifies a content of a web document that a user corresponding to a searcher reads, and displays advertising corresponding to the identified content for the user. The contextual advertising service may identify advertising which the user is interested in, from the web document that the user is currently reading. Also, the contextual advertising service may readily display the identified advertising for the user. In this aspect, the contextual advertising service is in the commercial spotlight.

As an example, when a user reads a web document about ‘Jejoo island’, an advertising server supporting the contextual advertising service may identify advertising associated with ‘travel to Jejoo island’, and display the identified advertising for the user.

However, the advertising identification method, as described above, analyzes a portion of keywords included in a web document, analogizes a content of the web document by large amounts, and identifies advertising corresponding to the analogized content of the web document. Accordingly, in the conventional advertising identification method, advertising unassociated with the content of the web document may be identified due to improper analysis of the keywords.

When displayed advertising is unassociated with a content of a web document that a user is currently reading, the user may have no interest in the advertising and also may have unpleasant feeling due to the unnecessary advertising.

Accordingly, a new advertising list creating model capable of identifying a relation with a content of a web page by utilizing various types of point values, and thereby creating an advertising list including only highly associated advertising is needed.

### BRIEF SUMMARY

An aspect of the present invention provides a method and system for creating an advertising list according to a value distribution, which can extract advertising information for contextual advertising and determine a location of each of the extracted advertising information in the advertising list by considering various types of point values, and thereby can retrieve advertising information, which is optimal for a content of a content page, and create the advertising list including the retrieved optimal advertising information.

Another aspect of the present invention also provides a method and system for creating an advertising list according to a value distribution, which can identify a matching degree between particular advertising information and a content of a content page by utilizing various types of assigned point values, and display advertising information, assigned with most point values, in a top portion of the advertising list, and thereby readily display advertising information, which is optimal for the content of the content page, for a user.

According to an aspect of the present invention, there is provided a method of creating an advertising list according to a value distribution, the method including the steps of: identifying a text-in-keyword from a content page, and searching a database for advertising information corresponding to the identified text-in-keyword, the content page being created according to a predetermined identification process; assigning a first value to each of the retrieved advertising information; extracting a predetermined number of advertising information from the database by referring to the assigned first value; assigning a second value to each of the extracted predetermined number of advertising information; and creating the advertising list where the predetermined number of advertising information is sorted according to a combined value of the first value and the second value.

According to another aspect of the present invention, there is provided a system for creating an advertising list according to a value distribution, the system including: an information search component identifying a text-in-keyword from a content page, and searching a database for advertising information corresponding to the identified text-in-keyword, the content page being created according to a predetermined identification process; a candidate target extractor extracting a predetermined number of advertising information from the database by referring to a first value, the first value being assigned to each of the retrieved advertising information by a point assignment component; and a list creator creating the advertising list where the predetermined number of advertising information is sorted according to a combined value of the first value and a second value, the second value being assigned to each of the extracted predetermined number of advertising information by the point assignment component.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a block diagram illustrating an operation of an advertising list creating system using a value distribution according to an exemplary embodiment of the present invention;

FIG. 2 is a block diagram illustrating a configuration of an advertising list creating system according to an exemplary embodiment of the present invention;

FIG. 3 illustrates an example of storing advertising information corresponding to a seed in a database according to an exemplary embodiment of the present invention;

FIG. 4 illustrates an example of creating an advertising list using a value distribution according to an exemplary embodiment of the present invention;

FIG. 5 illustrates an example of assigning a point to each of advertising information according to an exemplary embodiment of the present invention;

FIG. 6 is a flowchart illustrating a method of creating an advertising list using a value distribution according to an exemplary embodiment of the present invention; and

FIG. 7 is a flowchart illustrating an example of assigning an advertising point value to advertising information according to an exemplary embodiment of the present invention.

### DETAILED DESCRIPTION OF EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a module. One or more components can reside within a process and/or thread of execution, and a module or component can be localized on one computer and/or distributed between two or more computers.

As used herein, the terms “desktop,” “PC,” “local computer,” and the like, refer to computers on which systems (and methods) according to the invention operate. In the illustrated embodiments, these are personal computers, such as portable computers and desktop computers; however, in other embodiments, they may be other types of computing devices (e.g., workstations, mainframes, personal digital assistants or PDAs, music or MP3 players, and the like.)

The term ‘advertising list’ used throughout the present specification may indicate a list which sequentially includes a plurality of advertising information about an advertiser or corresponding to promotion and marketing materials about business items of the advertiser. Particularly, in the present exemplary embodiment, the advertising list may be created by utilizing advertising information corresponding to a content of the content page. In this instance, the content page is created in response to a search request from a user. Also, it is possible to optimally support a contextual advertising service by displaying the created advertising list and the content page for the user.

The term “contextual advertising” used throughout the present specification may indicate an advertising providing technique or advertising which is displayed corresponding to a content of a web document, i.e. a content page in the present specification. As an example, when a user is reading a web content about a mobile communication telephone, a predetermined advertising server supporting the contextual advertising may retrieve advertising information associated with the mobile communication telephone and display the retrieved advertising information for the user. In this instance, the advertising server may identify a content of the web document by utilizing a keyword included in the web document, or other information of the web document.

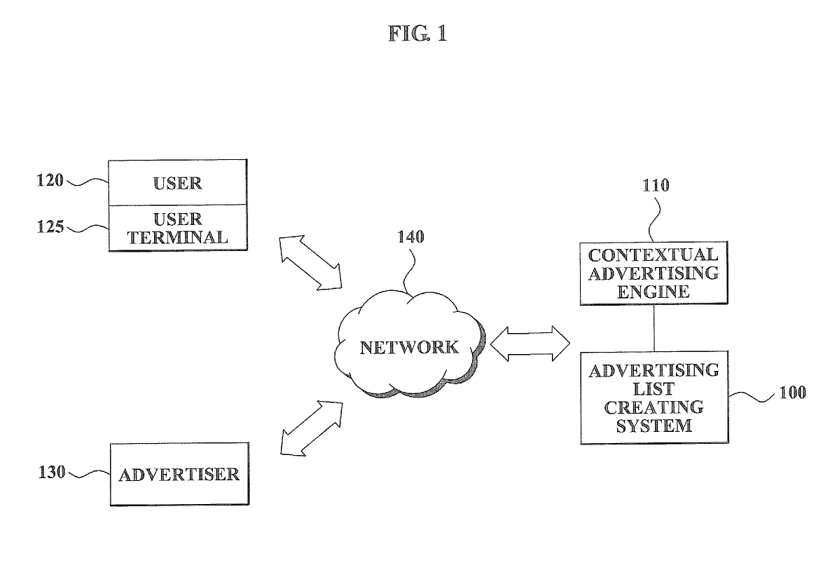

FIG. 1 is a block diagram illustrating an operation of an advertising list creating system 100 using a value distribution according to an exemplary embodiment of the present invention.

When providing a contextual advertising service for a user 120, the advertising list creating system 100 retrieves advertising information according to a content of a content page, and creates an advertising list to be displayed for the user 120 by utilizing the retrieved advertising information. Particularly, in the present exemplary embodiment, the advertising list creating system 100 extracts advertising information as an advertising candidate target to be included in the advertising list, and determines a location of each of the extracted advertising information according to various types of point values, such as an advertising point value, a seed point value, a description point value, a feedback point value, and the like. Accordingly, the advertising list creating system 100 may create an optimal advertising list corresponding to the content of the content page.

As described above, the advertising list is created by sorting a plurality of advertising information which is retrieved according to the content of the content page. In this instance, the advertising information may be identified by a seed of the content page. Specifically, the advertising list creating system 100 may determine the content of the content page for the user 120 to read as a seed, retrieve advertising information corresponding to the seed, and utilize the retrieved advertising information to create the advertising list.

In this instance, the seed indicates a group of keywords or a group of advertisers having an identical property. As an example, a keyword group ‘steak and salad’, an advertiser group ‘restaurant and steak shop’, and the like may be associated with a seed ‘family restaurant’. Also, all advertising information associated with the keyword group or the advertiser group may correspond to the seed ‘family restaurant’. Accordingly, when the seed ‘family restaurant’ is determined as a seed of a predetermined content page, the advertising list creating system 100 may retrieve all advertising information corresponding to the seed ‘family restaurant’.

A contextual advertising engine 110 may indicate an advertising service server which supports an advertising service by displaying the content page and either the advertising list or advertising information for the user 120. In this instance, the advertising information is retrieved in association with the content page that the user 120 reads.

The user 120 may indicate an Internet user which maintains a user terminal 125 to access the contextual advertising engine 110, and utilizes the content page and advertising information (advertising list) via the user terminal 125.

The advertiser 130 may indicate an operator of a commercial website which displays advertising information of the advertiser 130 corresponding to the content of the content page, and induces the user's access to a corresponding website according to the user's click on the displayed advertising information.

The user terminal 125 maintains a connection state with the advertising list creating system 100 or the contextual advertising engine 110 via a network 140, such as the Internet and the like. Also, the user terminal 125 realizes an advertising list corresponding to the content of the content page that the user 120 reads, and displays the advertising list for the user 120.

When determining advertising information as an advertising candidate target or when determining a location of each of advertising information in the advertising list, the advertising list creating system 100 utilizes various types of point values which are assigned based on various types of elements. Accordingly, the advertising list creating system 100 functions to create the advertising list by retrieving advertising information optimally corresponding to the content of the content page, and sorting the retrieved advertising information.

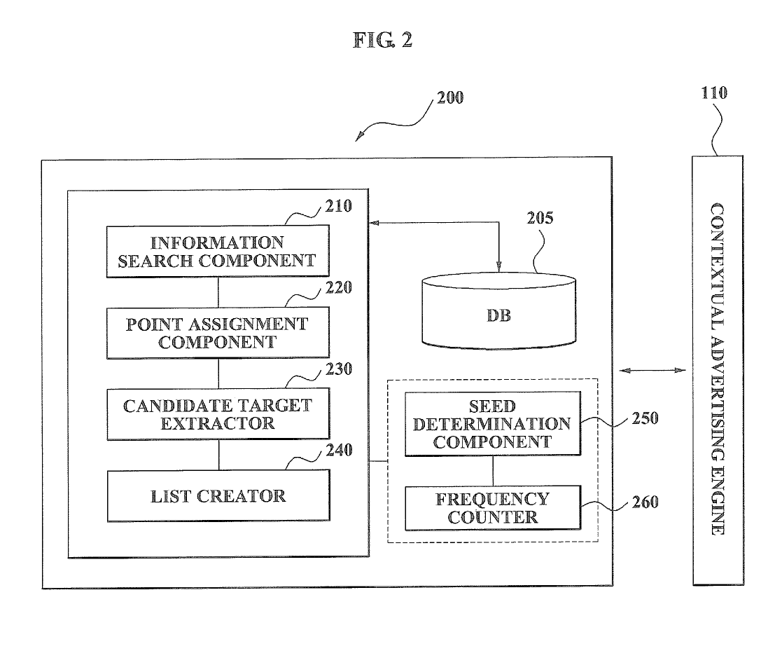

Hereinafter, a configuration of an advertising list creating system according to the present invention will be described with reference to FIG. 2.

FIG. 2 is a block diagram illustrating a configuration of the advertising list creating system 200 according to an exemplary embodiment of the present invention.

The advertising list creating system 200 may include an information search component 210, a point assignment component 220, a candidate target extractor 230, and a list creator 240.

Creating of a content page will be described prior to describing the configuration of the advertising list creating system 200.

The content page may correspond to medium information which transmits information to the user 120 via the network 140. The content page may be created through various types of processes. As an example, according to the present exemplary embodiment, a content page corresponding to a search keyword may be created in response to a search request, which is created when a user enters the search keyword in a search site. A search engine is generally in charge of creating a content page corresponding to the search keyword. In this instance, the search engine may appropriately search for a user's desired content and create the content page using the retrieved content. The content page may include a text-in-keyword. The text-in-keyword is utilized when reading advertising information according to the contextual advertising.

Describing the configuration of the advertising list creating system 200, the information search component 210 identifies a text-in-keyword from a content page, and searches a database 205 for advertising information corresponding to the identified text-in-keyword. In this instance, the content page is created according to a predetermined identification process. Particularly, in the present exemplary embodiment, the advertising list creating system 200 may retrieve pre-classified advertising information by using the determined seed of the content page. For the above operation, the advertising list creating system 200 includes a seed determination component 250 which determines the seed of the content page. The seed determination component 250 may determine the content of the content page depending upon a matching degree between the identified text-in-keyword and a keyword included in the pre-classified keyword group.

Also, the information search component 210 determines the seed of the content page by utilizing the text-in-keyword identified from the content page, and searches the database 205 for advertising information corresponding to the determined seed.

When identifying the text-in-keyword from the content page, the information search component 210 may identify the text-in-keyword by determining whether a keyword, purchased by the advertiser 130 and stored in the database 205, is included in a plurality of keywords included in the content page. As an example, when a content page including a content ‘family restaurant recommendation menu’ is created, the information search component 210 may identify keywords, ‘wellbeing salad’, ‘King & Queen steak’, and the like, as text-in-keywords, from a plurality of keywords included in the content page. In this instance, the keywords ‘wellbeing salad’, ‘King & Queen steak’, and the like, are selected, i.e. purchased by the advertiser 130.

Also, when identifying the text-in-keyword, the information search component 210 may analyze the content page and then select a predetermined keyword capable of representing the content of the content page as the text-in-keyword. As an example, when the content page including the content ‘family restaurant recommendation menu’ is created, the information search component 210 may analyze the entire content of the content page and identify keywords ‘wellbeing salad’, ‘King & Queen steak’, and the like, as text-in-keywords.

Also, the information search component 210 searches the database 205 for advertising information corresponding to the seed of the content page which is determined by the seed determination component 250.

For the above operation, the database 205 associates a keyword group or an advertiser group with the determined seed, and stores all advertising information associated with the keyword group or the advertiser group, in correspondence to the determined seed. Specifically, the database 205 includes advertising information, associated with the advertiser 130 or the keyword with an identical property, in one particular seed, and enables advertising information associated with the particular seed to be simultaneously displayed for the user 120 according to a single condition, for example, a seed call condition.

Specifically, the information search component 210 retrieves pre-classified advertising information according to the content of the content page.

The point assignment component 220 assigns a first value and a second to each of the retrieved advertising information. Here, the first value may be defined as a point which is utilized for determining a predetermined number of advertising information to be extracted from the database 205. In the present exemplary embodiment, examples of the first value include an advertising point value and a seed point value. Also, the second value may be defined as a point which is utilized for determining a location of each of the extracted predetermined number of advertising information in the advertising list. In the present exemplary embodiment, examples of the second value include a description point value and a feedback point value.

When assigning the advertising point value as the first value, the point assignment component 220 may assign the advertising point value which is determined by applying a predetermined weight when a keyword stored in the database 205 corresponding to the retrieved advertising information is substantially identical to the text-in-keyword. Specifically, when the keyword selected, i.e. the keyword purchased by the advertiser 130 of the retrieved advertising information substantially identical to the text-in-keyword identified from the content page, the point assignment component 220 assigns the advertising point value to each of the retrieved advertising information.

Also, the point assignment component 220 may apply the predetermined weight to the keyword, identical to the text-in-keyword, by considering various types of environments and thereby increase the advertising point value to be assigned.

In this instance, the point assignment component 220 may apply the predetermined weight so that a greater advertising point value may be assigned to a keyword less frequently selected, i.e. purchased by the advertiser 130. Specifically, when the keyword purchased by the advertiser 130 to register the advertising information, i.e. the keyword identical to the text-in-keyword, is identical to the keyword less frequently selected by other advertisers, the point assignment component 220 may substantially increase the advertising point value by applying the predetermined weight. As described above, it is possible to induce the advertiser 130 to select, i.e. purchase, an unpopular keyword by applying the weight.

Assuming that the keyword ‘King & Queen steak’, identified as the text-in-keyword in the above-described example, corresponds to the unpopular keyword less frequently selected (purchased) by the advertisers, the point assignment component 220 may assign a comparatively greater advertising point value to advertising information ‘ΔΔ steak’ corresponding to the keyword ‘King & Queen steak’ among the retrieved advertising information.

Also, the point assignment component 220 may apply the predetermined weight so that a greater advertising point value may be assigned to a longer keyword. Specifically, when the keyword purchased by the advertiser 130 to register the advertising information has a length greater than or equal to a predetermined length, the point assignment component 220 may substantially increase the advertising point value by applying the weight in proportion to the predetermined length. Applying of the weight depends upon the reasoning that a longer keyword includes more information in the keyword. Accordingly, the point assignment component 220 may apply the weight so that a greater advertising point value may be assigned in proportion to the length of the keyword.

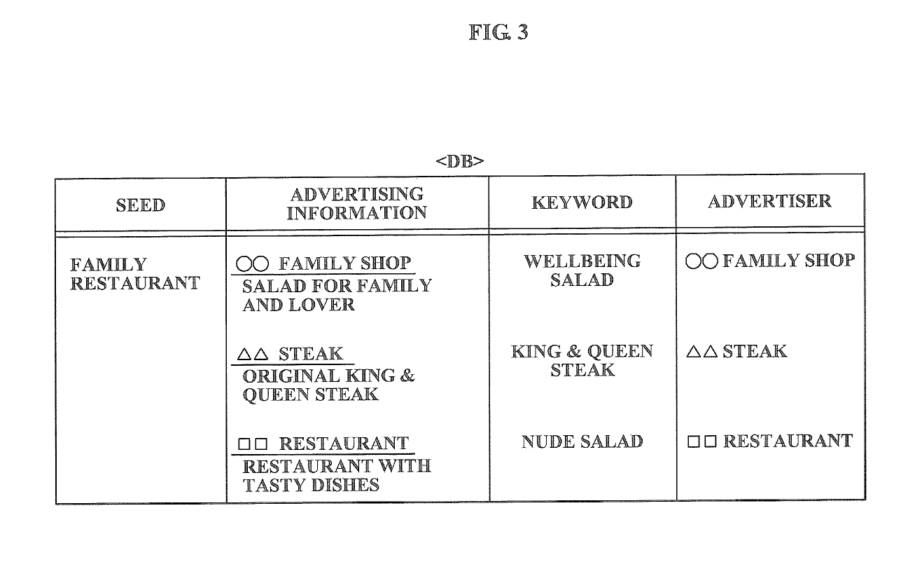

Assuming that the keyword ‘King & Queen steak’, identified as the text-in-keyword in the above-described example, corresponds to a keyword having a length greater than five letters corresponding to a specified number of letters, the point assignment component 220 may assign the advertising point value to advertising information ‘ΔΔ steak’ corresponding to the keyword ‘King & Queen steak’ in proportion to seven letters, excluding spaces, as illustrated in FIG. 3.

Also, the point assignment component 220 may apply the predetermined weight by considering a number of times that the keyword is included in the content page. Specifically, the point assignment component 220 may count a number of times that the keyword purchased by the advertiser 130 to register the advertising information, i.e. the keyword identical to the text-in-keyword, is included in the content page, and may apply the predetermined weight to substantially increase the advertising point value in proportion to the counted number of times. Applying of the weight depends upon the reasoning that advertising information corresponding to a keyword, frequently included in the content page, reflects the content of the content page. The point assignment component 220 may apply the weight so that the advertising point value may be assigned to the retrieved advertising information in proportion to the number of times that the keyword is included in the content page.

Assuming that the keyword ‘King & Queen steak’, identified as the text-in-keyword in the above-described example, is included in the content page five times, the point assignment component 220 may assign the advertising point value to advertising information ‘ΔΔ steak’ corresponding to the keyword ‘King & Queen steak’ in proportion to the counted number of times, i.e. five times, as illustrated in FIG. 3.

Also, the point assignment component 220 may apply the predetermined weight so that a greater advertising point value may be assigned to corresponding advertising information when the text-in-keyword is included in description information of the advertising information. Specifically, when the keyword purchased by the advertiser 130 to register the advertising information, i.e. the keyword identical to the text-in-keyword, is identical to the keyword included in the description information of the advertising information, the point assignment component 220 may apply the predetermined weight to substantially increase the advertising point value of corresponding advertising information.

In the above-described example, the keyword ‘King & Queen steak’, identified as the text-in-keyword, is included in description information ‘original King & Queen steak’ of the retrieved advertising information ‘ΔΔ steak’. Accordingly, the point assignment component 220 may apply the predetermined weight so that an additional advertising point value may be assigned to the advertising information ‘ΔΔ steak’, as illustrated in FIG. 3.

When assigning a seed point value, the point assignment component 220 may determine the size of the seed point value in proportion to reliability information about a keyword group.

The reliability information about the keyword group is created by utilizing a matching degree between the identified text-in-keyword and a keyword of the keyword group.

To create the reliability information about the keyword group, the advertising list creating system may further include the seed determination component 250. Specifically, the seed determination component functions to create the reliability information about the keyword group by utilizing the matching degree between the identified text-in-keyword and a keyword of the keyword group. Also, the seed determination component 250 may determine a seed of the content page by referring to the created reliability information.

Specifically, the point assignment component applies the seed point value to each of the retrieved advertising information by considering the reliability information created by the seed determination component 250.

In the above-described example, the seed of the content page is determined as ‘family restaurant’, and keywords ‘wellbeing salad’ and ‘King & Queen steak’, identified as text-in-keywords, are all included in the database 205 as keywords of the keyword group associated with the seed ‘family restaurant’. Accordingly, the point assignment component 220 may assign a maximum seed point value to each of the extracted advertising information.

Either the advertising point value or the seed point value may be utilized as the first value to extract a predetermined number of advertising information, which is retrieved by referring to the text-in-keyword, from the database 205.

In this instance, the advertising information may be extracted from the database 205 by the candidate target extractor 230. The candidate target extractor 230 extracts the predetermined number of advertising information from the database 205 by referring to the first value. In this instance, the first value is assigned to each of the retrieved advertising information. Also, N may be arbitrarily set by an operator of the present system according to a number of advertising information which is allowed to be displayed in the advertising list. As an example, when N is set to 3, the candidate target extractor 230 may select three advertising information of which the first value is within the top three, from the retrieved advertising information, and extract the three selected advertising information from the database 205.

When assigning description information as the second value, the point assignment component 220 assigns a description point value, which is determined by applying a predetermined weight when the identified text-in-keyword is included in description information of the extracted advertising information. Specifically, when the text-in-keyword identified from the content page is included in the description information of the advertising information extracted as the advertising candidate target, the point assignment component 220 may additionally assign the description point value, as the second value, to the advertising information. In this instance, the point assignment unit 220 may apply a predetermined weight depending upon a current status concerning the description information of the advertising information, and thereby apply a different description point value to each of the advertising information. A method of applying the predetermined weight may be similar or identical to the method of applying the predetermined weight to the advertising point value, as described above, and thus detailed descriptions related thereto will be omitted.

Assuming that three advertising information is extracted by the candidate target extractor 230, the point assignment component 220 may identify that the keyword ‘King & Queen steak’, identified as the text-in-keyword, is included in description information ‘original King & Queen steak’ of the extracted advertising information ‘ΔΔ steak’, and may assign the predetermined description point value to the advertising information ‘ΔΔ steak’.

When assigning a feedback point value as the second value, the point assignment component 220 may assign the feedback point value to the advertising information by referring to a frequency of appearance. In this instance, the frequency of appearance is counted with respect to each of keywords included in description information of the extracted predetermined number of advertising information.

The advertising list creating system 200 may further include a frequency counter 260 to count the frequency of appearance. Specifically, the frequency counter 260 may analyze description information of the advertising information extracted as the advertising candidate target, and count the frequency of appearance with respect to each of the keywords included in the description information. As an example, when a keyword A included in description information of particular advertising information appears a predetermined frequency with respect to the entire description information, the frequency counter 260 may count the frequency of appearance n of the keyword A, and assign the feedback point value to each of the advertising information, including the keyword A in the description information, by considering the frequency of appearance n.

The list creator 240 creates the advertising list where the predetermined number of advertising information is sorted according to a combined value of the first value and the second value. In this instance, the second value is assigned to each of the extracted predetermined number of advertising information by the point assignment component 220.

When creating the advertising list, the list creator 240 may determine a location of each of advertising information in the advertising list according to the size of the combined value. As an example, the list creator 240 may determine the location of each of advertising information with a top combined value in a top portion of the advertising list.

The contextual advertising engine 110 may be controlled to display the created advertising list for the user 120 with the content page which is created in response to a search request from the user 120. In the present exemplary embodiment, an area distinguished from a display area of the content page may be constructed as a display area of the advertising list depending upon support of contextual advertising. In this instance, the contextual advertising engine 110 is controlled so that the advertising list created by the advertising list creating system 200 may be displayed on the display area. The advertising list may be readily displayed for the user 120 which reads the content page.

As described above, according to the present invention, it is possible to extract advertising information for contextual advertising and determine a location of each of the advertising information in an advertising list by considering various types of point values. Accordingly, it is possible to create the advertising list by retrieving optimal advertising information corresponding to the content of the content page and sorting the retrieved advertising information.

FIG. 3 illustrates an example of the database 205 storing advertising information corresponding to a seed according to an exemplary embodiment of the present invention.

As shown in FIG. 3, advertising information registered by the advertiser 130, which desires to utilize a contextual advertising service, is stored in the database 205 corresponding to a keyword. Also, a plurality of keywords with an identical property and a plurality of advertisers with an identical property are stored in the database 205 in association with a particular seed. Accordingly, a plurality of advertising information with an identical property may be simultaneously retrieved according to a single condition.

As an example, referring to FIG. 3, the advertising list creating system 200 may search the database 205 for advertising information, ‘◯◯ family shop’, ‘ΔΔ steak’, and ‘□□ restaurant’, corresponding to the seed ‘family restaurant’ of the content page. Specifically, the advertising list creating system 200 determines the seed of the content page to be displayed for the user 120, and retrieves all advertising information associated with the determined seed, from the database 205.

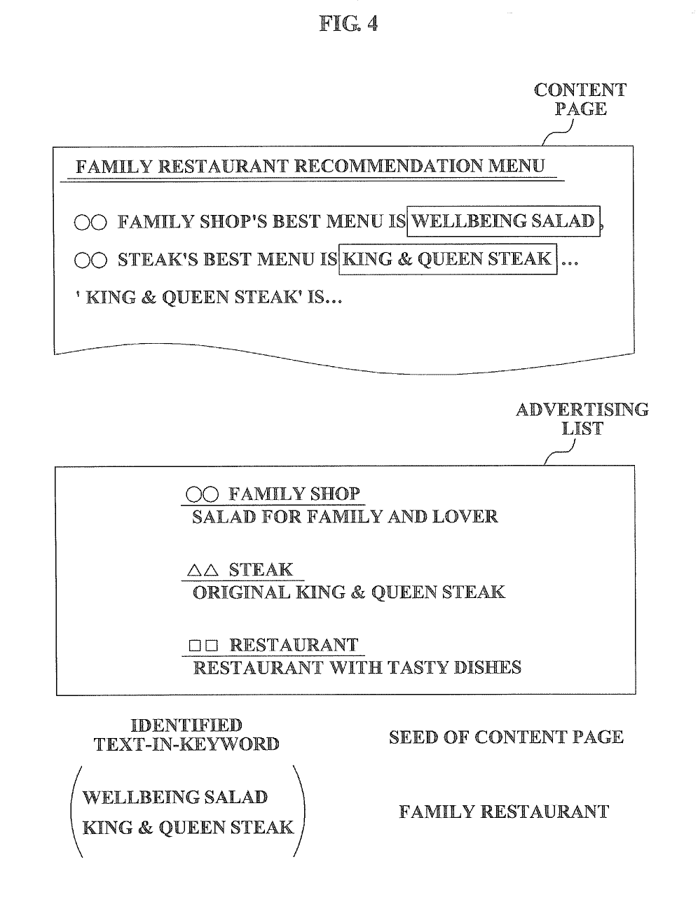

FIG. 4 illustrates an example of creating an advertising list using a value distribution according to an exemplary embodiment of the present invention.

In FIG. 4, a content page including a content ‘family restaurant recommendation menu’ is created.

The advertising list creating system 200 compares a keyword, selected (purchased) by the advertiser 130, with a keyword included in the content page, and then identifies text-in-keywords ‘wellbeing salad and King & Queen steak’ from the content page as shown in FIG. 4. Also, the advertising list creating system 200 may determine the seed ‘family restaurant’, including the identified text-in-keywords ‘wellbeing salad and King & Queen steak’ as a keyword group, as the seed of the content page by referring to the database 205 of FIG. 3. Accordingly, the advertising list creating system 200 may retrieve advertising information corresponding to the content of the content page, as shown in FIG. 4, as the advertising information, ‘◯◯ family shop’, ‘ΔΔ steak’, and ‘□□ restaurant’, in association with the seed ‘family restaurant’.

The advertising list creating system 200 may assign the first value and the second value to each of the retrieved advertising information and thereby determine advertising information as an advertising target candidate and a location of each of the advertising information in the advertising list.

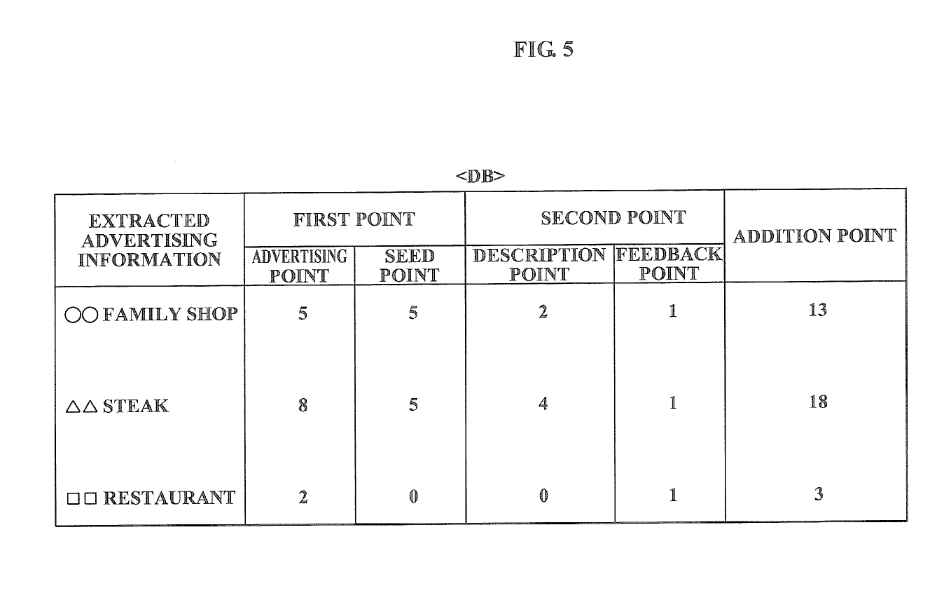

FIG. 5 illustrates an example of assigning a point value to each of advertising information according to an exemplary embodiment of the present invention.

As described above, the first value may indicate a point value which is utilized for selecting advertising information, to be substantially extracted from the database 205, from the retrieved advertising information. Also, the second value may indicate a point value which is utilized for determining a location of each of the extracted advertising information in the advertising list.

In FIG. 5, the advertising point value and the seed point value are assigned as the first value, and the description point value and the feedback point value are assigned as the second value with respect to each of the retrieved advertising information ‘◯◯ family shop’, ‘ΔΔ steak’, and ‘□□ restaurant’ as illustrated in FIG. 4.

The advertising list creating system 200 may assign an advertising point value applied with a predetermined weight when a keyword selected (purchased) by the advertiser 130 corresponds to at least one of i) a less frequently selected keyword, ii) a keyword having a length greater than or equal to a predetermined length, iii) a keyword frequently included in a content page, and iv) a keyword included in description information. As an example, the advertising list creating system 200 may assign advertising point value ‘8’, greater than advertising point value assigned to other advertising information, to the advertising information ‘ΔΔ steak’ which corresponds to iii) the keyword frequently included in the content page and iv) the keyword included in description information, as illustrated in FIG. 5.

Also, the advertising list creating system 200 may identify that the keyword ‘King & Queen steak’ purchased by the advertiser 130 of the advertising information ‘ΔΔ steak’ is included in the pre-classified keyword group, and then may additionally assign seed point values ‘5’ to the advertising information.

In this instance, when only three advertising information is allowed to be extracted as advertising candidate targets, i.e. N=3, the advertising list creating system 200 may extract the advertising information, in an order of ‘◯◯ family shop’, ‘ΔΔ steak’, and ‘□□ restaurant’, from the database 250 by referring to the first value. Here, the first value corresponds to either the advertising point value or the seed point value.

Also, the advertising list creating system 200 may assign the description point value depending upon whether the keyword selected by the advertiser 130 is included in description information of corresponding advertising information, or the feedback point value based on the frequency of appearance with respect to each of keywords included in the description information of extracted advertising information.

In FIG. 5, the advertising list creating system 200 identifies that the keyword ‘King & Queen steak’, purchased by the advertiser 130, is included in the description information of the advertising information ‘ΔΔ steak’, and assigns description point values ‘4’ to the advertising information ‘ΔΔsteak’.

Also, a keyword ‘steak’, included in the description information of the advertising information ‘ΔΔ steak’, appears only once with respect to the description information of the entire advertising information. Accordingly, the advertising list creating system 200 may count the frequency of appearance of the keyword ‘steak’ as ‘1’, and assign feedback point value ‘1’ corresponding to the counted frequency of appearance ‘1’.

The advertising list creating system 200 adds the first value and the second value with respect to each of the extracted advertising information, and determines a location of each of the extracted advertising information in the advertising list according to a combined value. As an example, in FIG. 5, the combined value of the advertising information ‘ΔΔ steak’ is ‘18’ greater than other advertising information. The advertising list creating system 200 may determine the location of each of the advertising information ‘ΔΔ steak’ to be displayed in a top portion of the advertising list. Specifically, the advertising list creating system 200 creates the advertising list which displays the advertising information ‘ΔΔ steak’ in the top portion, and displays the advertising list and the content page for the user 120, as illustrated in FIG. 4.

As described above, according to the present invention, a matching degree between particular advertising information and a content of a content page can be identified based on various types of point values assigned according to various types of conditions. In this instance, advertising information with highest point value is displayed in a top portion of the advertising list. Accordingly, it is possible to readily display advertising information, optimal for the content of the content page, for the user 120.

Hereinafter, an operational flow of an advertising list creating system according to an exemplary embodiment of the present invention will be described in detail.

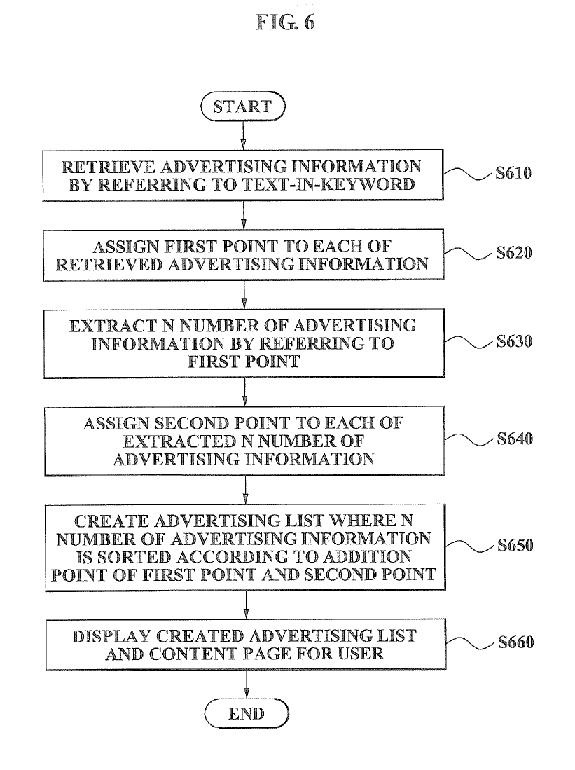

FIG. 6 is a flowchart illustrating a method of creating an advertising list using a value distribution according to an exemplary embodiment of the present invention.

The method of creating an advertising list is performed by the above-described advertising list creating system 200.

In operation S610, the advertising list creating system 200 identifies a text-in-keyword from a content page, and searches the database 205 for advertising information corresponding to the identified text-in-keyword to retrieve the advertising information. In this instance, the content page is created according to a predetermined identification process. Operation S610 is a process of identifying the text-in-keyword from the content page, and searching the database 205 to retrieve a group of advertising information corresponding to a seed which is determined according to the identified text-in-keyword.

When identifying the text-in-keyword, the advertising list creating system 200 may identify a keyword, selected (purchased) by the advertiser 130 and stored in the database 205, as the text-in-keyword from a plurality of keywords included in the content page. According to another exemplary embodiment, the advertising list creating system 200 may identify a predetermined keyword corresponding to a content of the content page as the text-in-keyword.

When determining the seed, the advertising list creating system 200 may determine a keyword group with highest reliability information and a seed associated with the keyword group, depending upon a matching degree between the identified text-in-keyword and a keyword included in the keyword group, for example, reliability information.

In operation S620, the advertising list creating system 200 assigns a first value to each of the retrieved advertising information. Operation S620 is a process of assigning the first value to each of the retrieved advertising information. In this instance, the first value corresponds to a reference point value for selecting a predetermined number of advertising information to be extracted.

In the present exemplary embodiment, the first value may indicate an advertising point value which is determined by applying a predetermined weight when a keyword stored in the database corresponding to the retrieved advertising information is substantially identical to the text-in-keyword.

Also, in the present exemplary embodiment, the first value may indicate a seed point value which determines the point value in proportion to reliability information about a keyword group. In this instance, the reliability information is created, depending upon a matching degree between the identified text-in-keyword and a keyword of the keyword group.

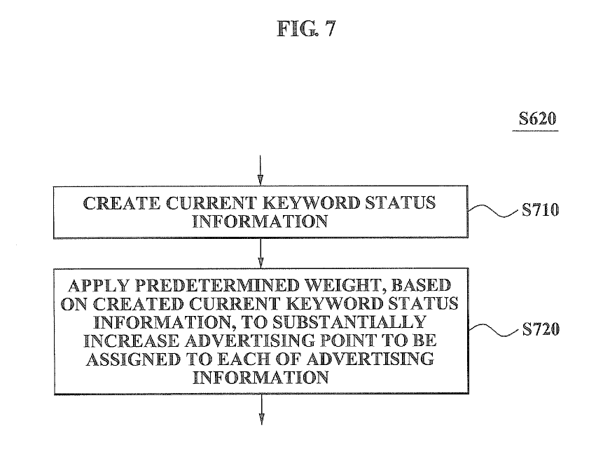

FIG. 7 is a flowchart illustrating an example of assigning an advertising point value to advertising information according to an exemplary embodiment of the present invention.

In operation S710, the advertising list creating system 200 searches the database 205 for advertising information corresponding to an identified text-in-keyword, and creates current keyword status information about a keyword associated with the retrieved advertising information. Specifically, the current keyword status information is created based on various types of current statuses associated with the keyword selected by the advertiser 130. As an example, in operation S710, the advertising list creating system 200 determine whether the keyword selected by the advertiser 130 corresponds to at least one of i) a less frequently selected keyword, ii) a keyword having a length greater than or equal to a predetermined length, iii) a keyword frequently included in a content page, and iv) a keyword included in description information, and thereby creates the current keyword status information.

In operation S720, the advertising list creating system 200 applies a predetermined weight, based on the created current keyword status information, to substantially increase the advertising point value to be assigned to each of the advertising information. Operation S720 is a process of identifying, using the current keyword status information, whether the keyword selected by the advertiser 130 substantially contains the content of the content page, and assigning a greater advertising point value to advertising information associated with the keyword which substantially contains the content of the content page.

As an example, when the keyword stored in the database 205 corresponding to the retrieved advertising information is substantially identical to the keyword, i.e. an unpopular keyword, selected by the advertiser 130 less than or equal to the predetermined frequency, the advertising list creating system 200 may apply the predetermined weight to increase the advertising point value by referring to the predetermined frequency.

Also, when the keyword stored in the database 205 corresponding to the retrieved advertising information has a length greater than or equal to the predetermined length, the advertising list creating system 200 may apply the predetermined weight to substantially increase the advertising point value by referring to the predetermined length.

Also, the advertising list creating system 200 may apply the predetermined weight to substantially increase the advertising point value in proportion to a number of times that the keyword stored in the database 205 corresponding to the retrieved advertising information is included in the content page.

Also, when the keyword stored in the database 205 corresponding to the retrieved advertising information is included in the description information of the advertising information, the advertising list creating system 200 may apply the predetermined weight to substantially increase the advertising point value.

As described above, according to the present invention, it is possible to appropriately determine whether to apply a predetermined weight to an advertising point value by considering current keyword status information about a keyword selected by the advertiser 130.

Referring again to FIG. 6, in operation S630, the advertising list creating system 200 extracts a predetermined number of advertising information from the database 205 by referring to the assigned first value. Operation S630 is a process of extracting the predetermined number of advertising information as an advertising candidate target. In this instance, the predetermined number indicates a numerical value which is set according to a number of advertising information which is allowed to be displayed in the advertising list.

In operation S640, the advertising list creating system 200 assigns a second value to each of the extracted predetermined number of advertising information. Operation S640 is a process of assigning the second value which is utilized to determine a display location in the advertising list.

In the present exemplary embodiment, the second value may indicate a description point value which is determined by applying a predetermined weight when the identified text-in-keyword is included in description information of the extracted advertising information.

Also, in the present exemplary embodiment, the second value may indicate a feedback point value which determines the point value by referring to a frequency of appearance with respect to each of keywords included in description information of the extracted predetermined number of advertising information.

In operation S650, the advertising list creating system 200 creates the advertising list where the predetermined number of advertising information is sorted according to a combined value of the first value and the second value. Operation S650 is a process of determining a location of each of advertising information in the advertising list according to the combined value and displaying the advertising information according to the determined location. Also, the advertising list creating system 200 may make the text-in-keyword correspond to the created advertising list, and thereby provide an environment capable of creating the advertising list to be displayed for the user 120 with the content page.

In operation S660, the advertising list creating system 200 displays the created advertising list and the content page for the user 120. Operation S660 is a process of simultaneously displaying the content page and the advertising list for the user 120. In this instance, the content page is created by the contextual advertising engine 110 supporting contextual advertising, and the advertising list is created in association with the content of the content page.

As described above, according to the present invention, it is possible to determine advertising information to be extracted for contextual advertising, and determine a location of each of the extracted advertising information in the advertising list by considering various types of point values. Accordingly, it is possible to retrieve advertising information, which is optimal for a content of the content page, and create the advertising list including the retrieved optimal advertising information.

The advertising list creating method according to the above-described embodiment of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like, including a carrier wave transmitting signals specifying the program instructions, data structures, and the like. Examples of program instructions include both machine code, such as produced by a compiler, and files containing higher level code that may be executed by the computer using an interpreter.

According to the present invention, there is provided a method and system for creating an advertising list according to a value distribution, which can extract advertising information for contextual advertising and determine a location of each of the extracted advertising information in the advertising list by considering various types of point values, and thereby can retrieve advertising information, which is optimal for a content of a content page, and create the advertising list including the retrieved optimal advertising information.

Also, according to the present invention, there is provided a method and system for creating an advertising list according to a value distribution, which can identify a matching degree between particular advertising information and a content of a content page by utilizing various types of assigned point values, and display advertising information, assigned with most point values, in a top portion of the advertising list, and thereby readily display advertising information, which is optimal for the content of the content page, for a user.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that relative terms are intended to encompass different orientations of the device in addition to the orientation depicted in the Figures.

Moreover, it will be understood that although the terms first and second are used herein to describe various features, elements, regions, layers and/or sections, these features, elements, regions, layers and/or sections should not be limited by these terms. These terms are only used to distinguish one feature, element, region, layer or section from another feature, element, region, layer or section. Thus, a first feature, element, region, layer or section discussed below could be termed a second feature, element, region, layer or section, and similarly, a second without departing from the teachings of the present invention.

It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Further, as used herein the term “plurality” refers to at least two elements. Additionally, like numbers refer to like elements throughout.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow. The scope of the disclosure is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. Section 112, sixth paragraph, unless the element is expressly recited using the phrase “means for” or, in the case of a method claim, the element is recited using the phrase “step for.”

What is claimed is:

1. A method of creating an advertising list according to a value distribution, the method comprising the steps of:
identifying at least one text-in-keyword from a content page;
searching a database for advertising information corresponding to the identified text-in-keyword;
retrieving the searched advertising information;
assigning a first value to each of the retrieved advertising information;
extracting a predetermined number of advertising information from the database by referring to the assigned first value;
assigning a second value to each of the extracted advertising information; and
creating an advertising list where the predetermined number of advertising information is sorted according to a combined value of the first value and the second value.

2. The method of claim 1, wherein the first value corresponds to an advertising point value which is determined by applying a predetermined weight when a keyword stored in the database corresponding to the retrieved advertising information is substantially identical to the text-in-keyword.

3. The method of claim 2, wherein the step of assigning the first value comprises the steps of:
determining whether the keyword stored in the database corresponding to the retrieved advertising information is substantially identical to a keyword selected by an advertiser is less than or equal to a predetermined frequency; and
applying the predetermined weight to increase the advertising point value by referring to the predetermined frequency when the keyword stored in the database corresponding to the retrieved advertising information is substantially identical to the keyword selected by the advertiser is less than or equal to the predetermined frequency.

4. The method of claim 2, wherein the step of assigning the first value comprises the steps of:
determining whether the keyword stored in the database corresponding to the retrieved advertising information has a length greater than or equal to a predetermined length; and
applying the predetermined weight to increase the advertising point value by referring to the predetermined length when the keyword stored in the database corresponding to the retrieved advertising information has a length greater than or equal to the predetermined length.

5. The method of claim 2, wherein the step of assigning the first value comprises the steps of:
counting a number of times that the keyword stored in the database corresponding to the retrieved advertising information is included in the content page; and
applying the predetermined weight to increase the advertising point value in proportion to the counted number of times.

6. The method of claim 2, wherein the step of assigning the first value comprises the steps of:
determining whether the keyword stored in the database corresponding to the retrieved advertising information is included in description information of the advertising information; and
applying the predetermined weight to increase the advertising point value when the keyword stored in the database corresponding to the retrieved advertising information is included in the description information of the advertising information.

7. The method of claim 1, further comprising the step of:
creating reliability information about a keyword group, the reliability information being determined by degree of matching between the identified text-in-keyword and a keyword of the keyword group,
wherein the first value corresponds to a seed point value which determines a point value in proportion to the reliability information.

8. The method of claim 1, wherein the second value corresponds to a description point value which is determined by applying a predetermined weight when the identified text-in-keyword is included in description information of the extracted advertising information.

9. The method of claim 1, further comprising the step of:
counting a frequency of appearance with respect to each of the keywords included in description information of the extracted predetermined number of advertising information,
wherein the second value corresponds to a feedback point value which determines a point value by referring to the counted frequency of appearance.

10. The method of claim 1, wherein the identification process 1) creates the content page in response to a search request from a user, and 2) identifies a keyword, as the text-in-keyword, from keywords included in the created content page, the keyword matching the same keyword stored in the database.

11. The method of claim 10, further comprising the step of:
displaying the created advertising list and the content page for the user.

12. A computer-readable recording medium storing a program for implementing the method recited in claim 1.

13. A system for creating an advertising list according to a value distribution, the system comprising:
an information search component configured for identifying a text-in-keyword from a content page and for searching a database for advertising information corresponding to the identified text-in-keyword;
a candidate target extractor configured for extracting a predetermined number of advertising information from the database by referring to a first value, the first value being assigned to each of the retrieved advertising information by a point assignment component; and
a list creator configured for creating the advertising list where the predetermined number of advertising information is sorted according to a combined value of the first value and a second value, the second value being assigned to each of the extracted predetermined number of advertising information by the point assignment component.

14. The system of claim 13, wherein the point assignment component assigns an advertising point value, as the first value, which is determined by applying a predetermined weight when a keyword stored in the database corresponding to the retrieved advertising information is substantially identical to the text-in-keyword.

15. The system of claim 14, wherein the point assignment component applies the predetermined weight to increase the advertising point value by referring to a predetermined frequency when the keyword stored in the database corresponding to the retrieved advertising information is identical to the keyword selected by the advertiser less than or equal to the predetermined frequency.

16. The system of claim 14, wherein the point assignment component applies the predetermined weight to increase the advertising point value by referring to a predetermined length when the keyword stored in the database corresponding to the retrieved advertising information has the length greater than or equal to the predetermined length.

17. The system of claim 14, wherein the point assignment component counts a number of times that the keyword stored in the database corresponding to the retrieved advertising information is included in the content page, and applies the predetermined weight to increase the advertising point value in proportion to the counted number of times.

18. The system of claim 13, further comprising:
a seed determination component creating reliability information about a keyword group, the reliability information being determined by degree of matching between the identified text-in-keyword and a keyword of the keyword group,
wherein the point assignment component assigns a seed point value as the first value, the seed point value determining the point value in proportion to the reliability information.

19. The system of claim 13, wherein the point assignment component assigns a description point value, as the second value, which is determined by applying a predetermined weight when the identified text-in-keyword is included in description information of the extracted advertising information.

20. The system of claim 13, further comprising:
a frequency counter configured for counting a frequency of appearance with respect to each of keywords included in description information of the extracted predetermined number of advertising information,
wherein the point assignment component assigns a feedback point value as the second value, the feedback point value determining the size of a point by referring to the counted frequency of appearance.
